(19) United States
(12) Patent Application Publication
(10) Pub. No.: US 2007/0063848 A1
(43) Pub. Date: Mar. 22, 2007

(54) A SECURITY DEVICE

(76) Inventor: Amit WEISMAN, (US)

Correspondence Address: LOWE HAUPTMAN BERNER, LLP, 1700 DIAGONAL ROAD, SUITE 300, ALEXANDRIA, VA, 22314, US

(21) Appl. No.: 10/595,266

(22) PCT Filed: Oct. 3, 2004
(86) PCT No.: PCT/IL04/00912

§ 371 Date: Apr. 3, 2006

(30) Foreign Application Priority Data
Oct. 3, 2003 (IL) 158280

(51) Int. Cl. G08B 23/00

(52) U.S. Cl. 340/573.1

(57) ABSTRACT

An improvement in metal and/or explosive detection device is disclosed, the improvement includes incorporating into the detection device a disablement unit designed to temporarily and reversibly incapacitate a human, so that immediately after he is disabled he presents no threat to the security personnel, however after a certain recovery period there are no residual effects from the disablement. Accordingly, various embodiments of detection devices are disclosed, comprising at least one detection unit for recognizing metals and/or explosives and at least one disablement unit for temporarily and reversibly incapacitate a human.

### FIELD OF THE INVENTION

The present invention is generally in the field of homeland security and particularly in the field of detecting concealed explosives.

### BACKGROUND OF THE INVENTION

Based on the fact that the use of explosives regularly involves the use of metals (either as a basic material from which weapons are normally constructed, or as an efficient carrier of explosion blast) law enforcement and security personnel will often utilize hand-held metal detector devices to check the public for concealed weapons at the entrance to government offices, commercial establishments, courthouses or other locations. Explosive detectors (named also explosive sniffers, electronic/artificial noses, or the like) are also being constantly developed and it is expected that sooner or later they would also become to a common use either as an alternative to or in combination with metal detectors. Lastly, efforts has been made to develop spectroscopic explosive detector which will have the ability of recognizing the presence of molecules of explosive material remotely, according to their spectrometric characteristics. Currently used explosive detectors utilize methods which require acquiring molecules of the explosives physically, therefore are to be used in physical contact or in very close proximity with the body of the suspected person. Metal detectors are also to be used in physical contact or in very close proximity with the body of the suspected person, since the detection is made by recognizing responses to a magnetic field conducted by the detector and induced into metals in its close proximity.

When the metal (and/or explosive) detector identifies the presence of a metallic object (and/or the presence of molecules of explosive material), typically an indication light or an audio signal, present on the wand-shaped hand-held detector will notify the security personnel. The security personnel will then challenge the individual by requesting a closer visual or manual search of the individual, or by drawing his officially issued weapon to forestall further violence. In the case of a true security threat, the security personnel will need to subdue the intended perpetrator with all due haste. This is especially true when the perpetrator is armed with a weapon of mass destruction, such as a suicide bomber, who, when challenged, will act without regard to his own safety and will detonate his explosive device.

In such instances, and in the presence of other violent individuals, speed is of the essence. A short instance of time exists between detection of the suspected weapon, and the time necessary for the security personnel to ready himself for action. The security personnel must drop his hand-held metal (and/or explosive) detector and free his hands to physically subdue the perpetrator, or to radio for reinforcements or draw his own weapon. The perpetrator may utilize those few seconds of time to act violently, for example, to activate a concealed bomb carried upon his person, which may cost the lives of the security personnel and of innocent bystanders. The need exists for a metal and/or explosives detecting device that addresses this problem and grants the security personnel more rapid response time.

U.S. Pat. No. 6,211,672 discloses a metal detector which can be strapped onto one's hand or wrist, to allow at least partial freedom of the hand for use in case of a true security risk.

U.S. Pat. No. 5,959,451 addresses the needs of security personnel, in that it is designed to be compact, and to contain a vibrator which transmits a tactile indication to the operator when metal is detected, to prevent the suspect from being alerted by an audio signal.

An additional dilemma exists for the security personnel when his hand-held detector indicates the presence of a metallic object or of explosive material. Should he respond by drawing his officially-issued weapon, hesitation in firing the weapon may allow a violent response from the suspect. However, over-zealousness in firing may result in maiming or killing a totally innocent citizen, who happened to have a significant amount of metal on his person, or who happened to treat explosives legally. Thus, use of a firearm in subduing a suspect is problematic, and over-use can be unfortunately irreversible. The need exists for a solution to security situations, which grants security personnel the ability of both a rapid and a reversible response to a suspected security threat.

### SUMMARY OF THE INVENTION

The present invention provides a solution to the fundamental need of security personnel for immediate response to the threat of concealed weapons, especially weapons of mass destruction.

The present invention further provides a solution for providing reversible response to a suspected security threat.

The invention generally relates to an improvement in metal and/or explosive detection device, the improvement includes incorporating into the detection device a disablement unit designed to temporarily and reversibly incapacitate a human, so that immediately after he is disabled he presents no is threat to the security personnel, however after a certain recovery period there are no residual effects from the disablement.

Accordingly, this invention discloses in a single device, a detection unit and a disablement unit. The disablement unit is designed to, so that immediately after he is disabled he presents no threat to the security personnel, however after a certain recovery period there are no residual effects from the disablement.

One preferred type of disablement unit, discussed below, comprises a stun-gun mechanism, which can deliver a high voltage electrical shock which will incapacitate the suspect for several minutes.

Thus the present invention provides a device for detecting metallic and/or explosive counter-bounds the device comprising:
a) at least one detection unit capable of recognizing the present of metals and/or of at least one type of explosive substance.
b) at least one disablement unit capable of temporarily and reversibly incapacitate a human;
c) a common housing or chassis supporting the disablement unit and the at least one detection unit;
d) a control unit for activating and controlling the device.
e) energy supply means capable of energizing the device components as necessary;
f) switching means for activating the disablement unit.

The term “metallic counter-bands” in the context of the invention refers to any metallic object whose carrier should be neutralized. Examples of metallic counter-bands are: weapons (guns, machine-gun), knives and explosives with or without metal elements aimed to increase blast damages.

According to various embodiments of the invention the detection unit includes a metal detection unit comprising:
a) a transmitter coil and a receiver coil defining a detection field.
b) a metal detector circuit connected to said transmitter and said receiver coils for detecting the presence of metal objects in said detection field;
c) indicating means for alerting the user to the presence of a metallic object.

Preferably, the disablement unit has a stun gun mechanism for discharging a high voltage electrical shock. According to various embodiments of the present invention, the stun gun mechanism comprises the following components:
a) a pair of electrically conductive electrodes protruding from the housing of the device or provided with means for being drawn out or shot out from the housing at spaced apart positions;
b) voltage multiplying arrangement capable of converting a low voltage of a power supply means (i.e. the voltage of a battery, of an AC network, or of a low AC voltage transformed from an AC network that is in use in the specific device, which are normally in the range of between 1 Volt DC and 220 Volt 50/60 Hertz AC) to a voltage (either of DC, AC or pulsating pattern) capable of immediately shocking/stunning a human exposed to it.
c) electrical circuit connecting the conductive electrodes to a battery through the voltage multiplying arrangement;
d) a manually operable switch operative to selectively make and break the electrical connection between at least one of the electrodes and the voltage multiplying arrangement or between the battery and the voltage multiplying arrangement, whereby a high voltage potential is created between the electrodes upon closing of the switch means.

Typically the electric shock delivered will have a voltage of approximately 50,000-400,000 volts, and a current of 1-4 mAmp. These parameters are sufficient to induce an immediate sharp pain and involuntary muscle spasms in an individual, when the current is applied to exposed skin for several seconds. The involuntary muscle spasms tend to last for several minutes, up to approximately 15 minutes, with no permanent damage to the individual. Thus the incapacitation achieved by this preferred type of a disablement unit is reversible.

When the disablement unit is designed to achieve these electrical parameters, the electrical shock delivered will not be transferred to the security personnel, even if the suspect takes hold of exposed body areas on the security personnel. It would be preferable during use, for the security personnel to apply the electric shock to the neck or face which are typically exposed and this eliminates the possibility of activating by the electricity possible concealed wiring, therefore avoiding electrical wiring which may be concealed under the clothing of the suspect, should he be wearing an explosive device. It has been noted that electrical shock as delivered by a stun gun is more efficient in subduing an individual, when it is applied to the neck or face, as opposed to the limbs. An electric shock delivered by the disablement unit is inaudible when the disablement unit is activated upon exposed skin, giving the suspect no advance warning.

According to other embodiments the electrodes are not necessarily protrude in advance from the housing of the device. Thus, according to various embodiments the electrodes are in a similar plane with a wall of the housing. According to other embodiments the electrodes are concealed inside the housing and are provided with extricating means (e.g. tensely drawn spring that can be triggered mechanically, or e.g. a solenoid that can be triggered electrically) which extracts and draws them out upon activation of the stun gun. According to various embodiments the present invention the electrodes are provided with shooting means, and with folded extendable wires, such that upon triggering the stun-gun on they are being shot from the housing to reach the body of the intended perpetrator remotely, in the range of between 5 cm and several tens of centimeters (e.g. 35 cm, or e.g. 60 cm) up to about Im. Upon strategic requirement for increasing the range, it is possible also to enlarge the range up to 20 or 25 meters (there are marketable taser stun guns having such shooting range). The shooting can be made either by springs, or by pneumatic pressure, which can be triggered either mechanically or electrically, as a matter of design. According to the embodiments comprising shooting means for shooting the electrodes, the electrodes are connected to their high voltage circuit through long enough wires which are temporarily rolled or folded inside the housing, thus are extendable to the appropriate maximum range designed for their shooting. The switching of the high voltage to the electrodes could be made simultaneously to the triggering, or with automatic delay (e.g. of about several tens of milliseconds) such that the high voltage is delivered through the wires after they are supposed to be reaching the body of the intended perpetrator.

Other types of disablement elements comprise an irritant, such as tear-gas or an anesthetic agent, capable of being emitted as a high pressure gas or a fluid from a canister upon activation of the switching means. An irritant or an anesthetic needs to be aimed towards the suspect's face, so as to reach the eyes, nose and mouth of the suspect. Caution should be taken by the security personnel to minimize his own contact with these substances.

The metal detection unit will preferably be entirely hand-held, and will contain a standard 9V battery as the power source, with an overall wattage of 0.3 watt (300 MW), a voltage of 7-9 volts (DC), a maximal current usage of 0.033 Amp (33 MA), and a working frequency of 22 KHz. This should grant the unit a detection capability of detecting a 38 mm pistol at a distance of approximately 20-30 cm, and of detecting a pocket knife at a distance of approximately 10-15 cm. A razor blade would be detected at a distance of approximately 5-10 cm. A preferable metal detecting unit will weigh approximately 300 grams. The battery may be rechargeable.

By one embodiment the disablement unit, the metal detection unit and the explosive detection unit are integral.

By another embodiment the metal detection unit, the explosive detection unit and the disablement unit are an assembly—i.e. capable of engagement. They may been manufactured individually, and assembled as a unit after manufacture in several simple steps. These assembly steps could include, for instance, screwing on, ratchet attachment, or attaching by other means known to assemble two or three units or components, e.g. the disablement unit to the housing of the metal detection unit, or e.g. the disablement unit and the explosive detection unit to the housing of the metal detection unit. This would be followed by electrical connection of the two or the three units, if they share a single battery. Alternatively, each unit may contain all components necessary for its activation, including the switching means and the electrical means for activation. One unit may be placed inside a predetermined area in the housing of the other unit; alternatively, the unit can be fitted on externally to the housing.

According to further embodiments of the present invention the device has communication means for transmitting alarm signals to a security headquarters, to a supervisor, to emergency forces, or the like, upon recognizing of a suspected counter-bands, or upon activation of the disablement unit. According to various embodiments the communication means are arranged for automatically activating remote systems (e.g. automatically closing and/or locking an entrance door or a barrier upon recognition of counter-bands).

According to various preferred embodiments of the present invention the disablement unit and the device for detecting counter-bands are controlled by a common control unit, and preferably utilize a common energy-source. The device of the present invention may be hand-held device energized by a battery. According to various preferred embodiments the battery is rechargeable. According to various variations of the invention the rechargeable battery is designed such that it could be recharged inside the device. According to other embodiments it is comprised inside a cartridge that may be replaced by a newly charged battery cartridge.

The device of the present invention may be also stationary (e.g. as a part of a stationary detection door, gate or passage). In such a case it can be energized from a conventional electric network (e.g. 115V 60 Hz, 230V 50 Hz, or an appropriate transformation of such voltages). The hand held device could also be designed to be energized directly from conventional AC network (either as an alternative or as additional option to its battery powering). When operated by AC, its rechargeable batteries can be recharged during its use.

According to various embodiments the disablement unit has an alarm arrangement selected from (a) visual alarm; (b) audio alarm; (c) vibration alarm; (d) a combination of at least two of ‘a’ to ‘c’.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A and 1B show two options for a metal detection unit that may be a part of the device of the invention;

FIG. 2 shows a device of the invention having a metal detection unit and a stun-gun as a disablement unit, both units being integral to the device.

FIG. 3 shows a device of the invention having a metal detection unit and a stun-gun as a disablement unit, and the two units adapted for being assembled with one another.

FIG. 4 shows a device of the invention having an explosive detection unit and a disablement unit.

FIG. 5 shows a device of the invention having a metal detection unit, an explosive detection unit, and a disablement unit incorporated to form one device.

FIG. 6 shows electrodes of a stun gun according to the invention provided with means to be drawn out from inside the device housing upon activation.

FIG. 6A shows the electrodes of FIG. 6 after being drawn out from the device housing.

FIG. 7 shows electrodes of a stun gun according to the invention provided with means to be shot out from inside the device housing upon activation, to reach at a body of an intended perpetrator from a distance, e.g. of several tens of centimeters.

### DETAILED DESCRIPTION OF THE INVENTION

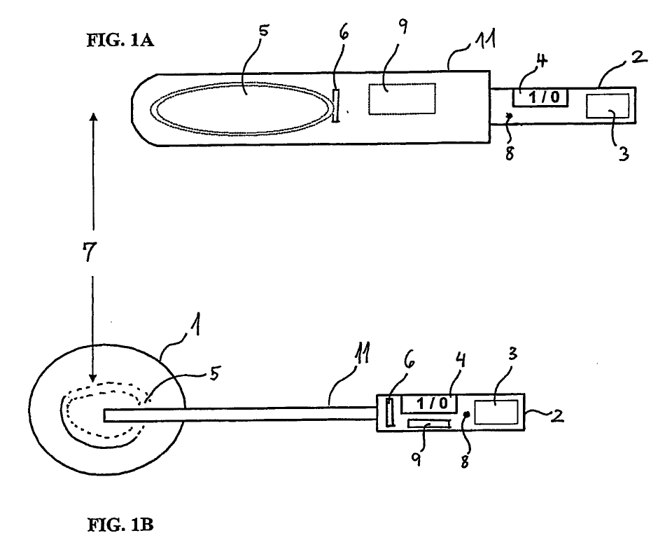

Referring to FIG. 1, the metal detection unit is illustrated. FIG. 1A depicts a hand-held wand-type metal detection unit. A housing (11) surrounds and supports the metal detection unit. The proximal end of the detection unit is the handle (2) which is grasped by the security personnel. The power supply (3) is a battery, and the on/off switching means (4) are depicted. The transmitter coil and the receiver coils which define the detection field (7) are present in a single coil assembly (5), and the detector circuit (6) is present adjacent to the coil assembly (5), and is in electrical communication with the coil assembly (5). The active detection field (7) is depicted, and this area must be moved over different areas on the subject being scanned for the presence of metallic objects. A control unit (9) processes the electrical signals and coordinates the operation of the unit. Indicator means (8) are present on the handle of the unit, and indicate, preferably by means of a visual display, the presence of a metallic object. The indicator means (8) may alternatively be audio means.

FIG. 1B depicts a detection unit having a detection plate (1) at its active detecting end. The shape of the housing (11) and the relative placement of the components are the main difference between the detection units of FIGS. 1A and 1B. In FIG. 1B, the transmitter coil and the receiver coils which determine the active detection field (7) are present in a single coil assembly (5), within the detection plate (1). The detector circuit (6) is present within the handle (2) of the detection unit, as are the power-supplying battery (3), the switching means (4), the control means (9) and the indicator means (8).

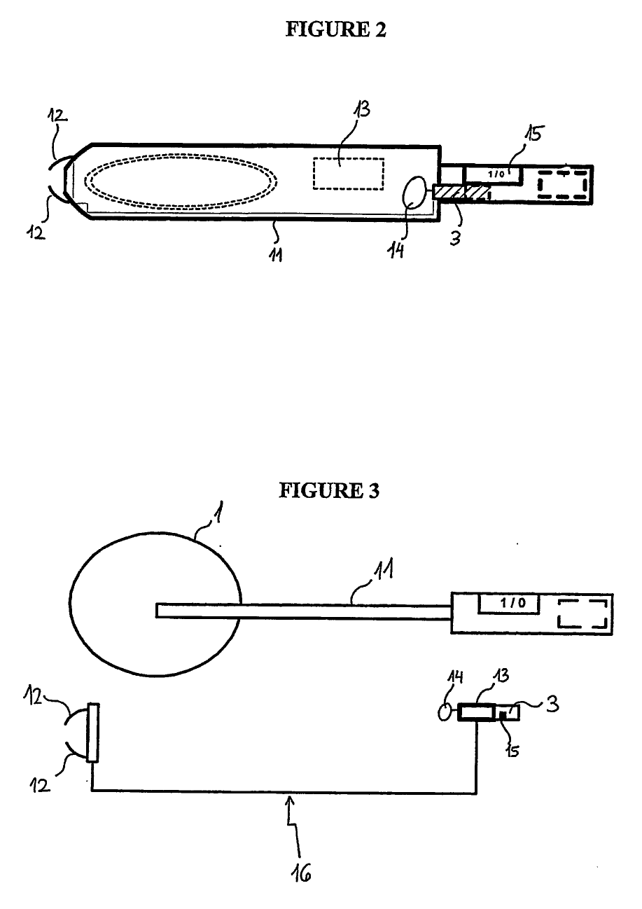

Referring to FIG. 2, the entire device is shown, including the preferred disablement unit which contains a stun-gun mechanism. A pair of electrodes (12) protrude from the distal end of the housing (11) at spaced apart positions. A circuit (13) is connected to the battery (3), and voltage increasing means (14) are included, to create a high voltage potential (from a relatively low voltage power supply source). A manually operable switch (15) is present to selectively make and break the electrical connection between at least one of the electrodes (12) and between the means (14) for increasing voltage (or according to another embodiment between the battery (3) and the means (14) for increasing voltage), whereby a high voltage potential is created between the electrodes upon closing of the switch means (15).

Referring to FIG. 3, a metal detection unit is shown of the detection-plate (1) type, which is designed to be assembled after manufacture to a disablement unit (16) having a stun-gun mechanism. The disablement unit is comprised of a pair of electrodes (12) at spaced apart positions, a circuit (13) connected to a battery (3), voltage increasing means (14) and a manually operable switch (15). All these can be snapped into appropriate places upon the housing (11) of the metal detection unit, as shown, to create a single device.

The device according to the present invention provides an effective and immediate solution to the threat presented to security personnel and secondarily to the general public, when a suspect must be searched for concealed weapons, and subdued immediately when these are found. Security personnel worldwide have been maimed and killed in the course of duty due to this problem, which the present invention provides an effective and rapid solution for.

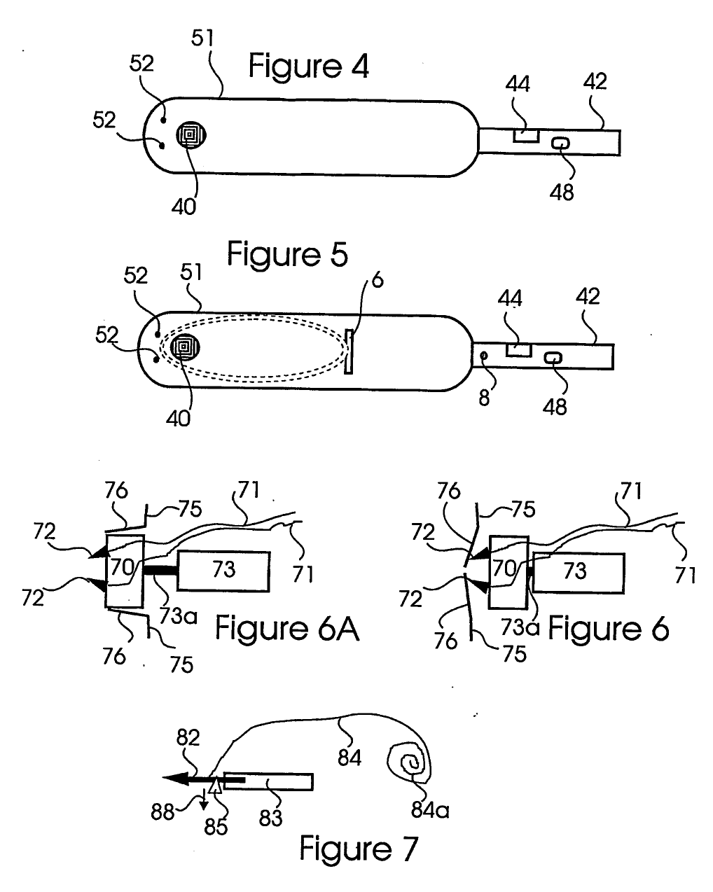

FIG. 4 shows a device of the invention having an explosive detection unit and a disablement unit. This embodiment differs from the one illustrated by FIG. 2 in that the detection unit is comprised of an explosive detector located inside the housing (51) and terminates with a nostril covered by a protecting grid (40) arranged in approximately the same plane of the housing wall, and covering an aperture in the wall, through which molecules from the intimate vicinity of a detected person can be sucked and detected. An indicator (48) alarms upon positive detection of an explosive material recognizable by the particular explosive detection unit provided inside the housing. The alarm may be visual (e.g. a blinking red light LED), acoustic (e.g. a beep or a tone), or a vibration that could be sensed by the user hand gripping the handle (42). According to various embodiments the alarm could be directed to earphones such that the user may hear the alarm privately. Another difference of the illustrated embodiment comparing to that of FIG. 2, is in the location of the electrodes (52) of the shocker (stun gun), which are placed on the housing wall near the end of the housing (and not on its edge as in FIG. 2). According to this embodiment the electrodes are substantially in the same plane of the housing wall and do not disturb the moving of the device over the body (and clothes) of the detected person.

FIG. 5 shows a device of the invention having a metal detection unit, an explosive detection unit, and a disablement unit incorporated to form one device. The device in the illustrated embodiment differs from the one illustrated by FIG. 4 in that it is further comprising metal detection unit having the detector circuit (6) (similar to that illustrated by FIG. 1), and by having on the handle (42) the indicator means (8) associated with the metal detection unit located inside the housing.

FIG. 6 shows electrodes of a stun gun according to the invention provided with means to be drawn out from inside the device housing upon activation. The electrodes (72) are supported on the electrodes basis (70) that is made from insulating material capable of withstanding the high voltages between the electrodes, and which is connected to a plunger (73a) of the solenoid (73). Before activation the electrodes are concealed behind the housing wall (75) and the pivotable flaps (76).

FIG. 6A shows the electrodes of FIG. 6 after being drawn out from the device housing. Upon recognition of a counter-band, and subject to the individual decision of the user to activate the stun-gun by pressing the appropriate switch, the solenoid (73) receives electrical signal and changes its plunger location from the position illustrated by FIG. 6, to the position illustrated by this FIG. 6A. Accordingly, the electrodes basis (70) pushes the electrodes (72) toward the pivotable flaps (76), which in turn are being opened thus letting the electrodes (72) to being drawn out into a contact with the body of the intended perpetrator. Simultaneously, the high voltage of the stun gun is being connected to the electrodes through the wires (71).

FIG. 7 shows electrode (82) of a stun gun according to the invention provided with means to be shot out from inside the device housing upon activation, to reach at a body of an intended perpetrator from a distance, e.g. of several tens of centimeters. The electrode (82) is connected to a high voltage of the stun gun circuitry through a folded (rolled-up) wire (84) which can be extend up to a maximal predetermined length when being pulled by the shot electrode (82) such that its folding (84a) is being opened and extracted. The means for shooting the electrode is pressurized gas held in a launcher (83) and cocked by the end of the electrode (82) which cannot move before activation due to a peg (85) which is stuck into the electrode. Upon activation by the user, the peg (85) is pulled out in the direction of arrow (88) (e.g. by means of a solenoid to which the peg is connected, and is activated by electrical signal upon switching on of the stun gun by its user), and the pressure of the gas imprisoned inside the launcher (83) shoots the electrode (82) with its associated wire (84) being rolled open, until reaching at the body of the perpetrator. Another electrode having similar launching mechanism is being shot simultaneously in a similar manner. According to other embodiments, the electrodes are arranged on a tip of an arrow, and the whole device is formed in the shape of a pistol or gun adapted to launch the arrow carrying the electrodes and extending the wires during its flow toward the targeted perpetrator.

1. In a device for detecting counter-bands the improvement including the incorporation of a disablement unit.

2. The improvement according to claim 1, wherein the disablement unit is comprising electrical shocker.

3. The improvement according to claim 1, wherein the disablement unit is comprising an irritant.

4. The improvement according to claim 3, wherein the irritant comprises tear gas or anesthetic agent.

5. The improvement according to claim 1, wherein the disablement unit and the device for detecting counter-bands are controlled by a common control unit.

6. The improvement according to claim 1, wherein the disablement unit and the device for detecting counter-bands utilize a common energy-source.

7. The improvement according to claim 1, wherein the disablement unit and the device for detecting counter-bands comprise communication arrangement with remotely located system.

8. The improvement according to claim 1, wherein the disablement unit has an alarm arrangement selected from (a) visual alarm; (b) audio alarm; (c) vibration alarm; (d) a combination of at least two of ‘a’ to ‘c’.

9. The improvement according to claim 1, wherein the disablement unit and the device for detecting counter-bands form a hand-held device.

10. The improvement according to claim 1, wherein the disablement unit and the device for detecting counter-bands form a stationary device.

11. A device for detecting counter-bounds comprising;
(a) at least one detection unit capable of recognizing the present of metals and/or of at least one type of explosive substance;
(b) at least one disablement unit capable of temporarily and reversibly incapacitate a human;
(c) a common housing or chassis supporting the disablement unit and the at least one detection unit;
(d) a control unit for activating and controlling the device;
(e) energy supply means capable of energizing the device components as necessary;
(f) switching means for activating the disablement unit.

12. A device according to claim 11 being hand held.

13. A device according to claim 11 wherein the disablement unit is a stun gun having a mechanism for discharging high-voltage electrical shock.

14. A device according to claims 11, wherein the disablement unit and the at least one detection unit are integral.

15. A device according to claims 11, wherein the disablement unit and the at least one detection unit are detachably engagable.

16. A device according to claims 11, wherein the at least one detection unit includes a metal detection unit comprising:
a) a transmitter coil and a receiver coil defining a detection field,
b) a metal detector circuit connected to said transmitter and said receiver coils for detecting the presence of metal objects in said detection field;
c) indicator for alerting the user to the presence of a metallic object; and
d) switch for activating the metal detection unit.

17. A device according to claim 13, further comprising a battery electrically connected to said stun-gun.

18. A device according to claim 13, wherein the stun-gun has a mechanism comprising the following components:
(a) a pair of electrically conductive electrodes protruding from the housing of the device or provided with means for being drawn out or shot out from the housing at spaced apart positions;
(b) voltage multiplying arrangement capable of converting a low voltage of a power supply means to a high voltage capable of immediately shocking a human exposed to it.
(c) electrical circuit connecting the conductive electrodes to a battery through the voltage multiplying arrangement;
(d) manually operable switch operative to selectively make and break the electrical connection between at least one of the electrodes and the voltage multiplying arrangement or between the battery and the voltage multiplying arrangement, whereby a high voltage potential is created between the electrodes upon closing of the switch means.

19. The device according to claim 13, wherein the high voltage electrical shock discharged from the stun-gun has a voltage of approximately between 50,000-400,000 volts, and a current of approximately between 1-4 mAmp.

20. The device according to claim 1, wherein the disablement unit is comprised of an irritant or an anesthetic agent, capable of being emitted as a high pressure gas or a fluid from a canister upon activation of the switching means.

21. A device according to claim 15, wherein the disablement unit is adapted for being assembled on a position external to the housing of the device, and can be detachably connected to the device.

22. A device according to claim 11 wherein the counter-band detection unit is capable of detection of counter-bands selected from the group consisting of: weapons, guns machine-guns, knives, metal chips, and explosives.

23. A metal detection unit adapted for detachable engagement with a disablement unit, said disablement unit capable of reversibly incapacitating a human; wherein said metal detection unit is comprised of:
a) a transmitter coil and a receiver coil defining a detection field,
b) a metal detector circuit connected to said transmitter and said receiver coils for detecting the presence of metal objects in said detection field;
c) indicating means for alerting the user to the presence of a metallic object;
d) a housing;
e) a control unit for activating the metal detection unit;
f) a battery electrically connected to said metal detector circuit for providing power from said battery to said metal detector circuit and to the components of the unit as necessary;
g) switch for activating the unit.

24. A disablement unit capable of reversibly incapacitating a human, adapted for assembly with a metal detector device.

25. The disablement unit of claim 24, wherein the disablement unit is comprised of a stun gun mechanism capable of discharging a high voltage electrical shock; said stun gun mechanism comprising:
a) a pair of electrically conductive electrodes protruding from the housing of said device or provided with means for being drawn out or shot out from the housing at spaced apart positions;
b) voltage multiplying arrangement capable of converting a low voltage of a power supply means to a high voltage capable of immediately shocking a human exposed to it;
c) electrical circuit connecting the conductive electrodes to a battery through the voltage multiplying arrangement;
d) manually operable switch operative to selectively make and break the electrical connection between at least one of the electrodes and the voltage multiplying arrangement or between the battery and the voltage multiplying arrangement, whereby a high voltage potential is created between the electrodes upon closing of the switch means.

26. The disablement element of claim 25, further including a battery.
